(19) United States
(12) Patent Application Publication
(10) Pub. No.: US 2024/0248165 A1
(43) Pub. Date: Jul. 25, 2024

(54) Maximum Likelihood Code Phase Discriminator for Position Estimation

(71) Applicant: NextNav France, Puteaux (FR)

(72) Inventors: Rabih CHRABIEH, Montrouge (FR); Nathan ARBEID, Paris (FR)

(73) Assignee: NextNav France, Puteaux, FR (FR)

(21) Appl. No.: 18/418,846

(22) Filed: Jan. 22, 2024

Related U.S. Application Data
(60) Provisional application No. 63/481,226, filed on Jan. 24, 2023.

(51) Int. Cl. G01S 5/14; G01S 5/02

(52) U.S. Cl. CPC G01S 5/145; G01S 5/021; G01S 5/0221

(57) ABSTRACT

A method involves receiving a ranging signal. A filtered ranging signal is generated using the ranging signal and used to determine a first estimated time of arrival (TOA) of the ranging signal. Multiple first time delay hypotheses of an actual TOA of the ranging signal are determined. A correlator vector is generated using the filtered ranging signal, a filtered local replica of the ranging signal, and the first time delay hypotheses. Multiple code phase discriminator vectors corresponding to second time delay hypotheses are generated, each code phase discriminator vector being based on estimated signal processing, filtering, and noise characteristics of the ranging signal for a respective second time delay hypothesis. A second estimated TOA of the ranging signal is generated using the correlator vector and the code phase discriminator vectors.

### RELATED APPLICATIONS

This application claims priority to U.S. Provisional Application No. 63/481,226, filed Jan. 24, 2023, all of which is incorporated by reference herein for all purposes.

### BACKGROUND

Determining the exact location of a mobile device (e.g., a phone, laptop computer, tablet, or another device) in an environment can be quite challenging, especially when the mobile device is located in an urban environment or is located within a building. Imprecise estimates of the mobile device's position may have “life or death” consequences for the user. For example, an imprecise position estimate of a mobile device, such as a mobile phone operated by a user calling 911, can delay emergency personnel response times. In less dire situations, imprecise estimates of the mobile device's position can negatively impact navigation applications by directing a user to the wrong location or taking too long to provide accurate directions.

An estimated location of a mobile device may be determined using time of arrival (TOA) estimates of wireless signals (“ranging signals”) received at the mobile device from either terrestrial (e.g., a wide area position system) or non-terrestrial transmitters (e.g., satellites) stationed at known locations and then performing trilateration, as is well understood in the art. Ranging signal receivers have thus become ubiquitous.

### SUMMARY

In some aspects, the techniques described herein relate to a method, including: receiving, at a receiver, a ranging signal from a transmitter, the ranging signal including a reference sequence; generating, by the receiver, a filtered ranging signal using the received ranging signal; estimating, by the receiver using the filtered ranging signal, a first estimated time of arrival (TOA) of the received ranging signal; generating, by the receiver, a filtered local replica of the received ranging signal; determining, by the receiver, a plurality of first time delay hypotheses of an actual TOA of the received ranging signal; generating, by the receiver, a correlator vector using the filtered ranging signal, the filtered local replica of the ranging signal, and the plurality of first time delay hypotheses; generating, by the receiver, a plurality of code phase discriminator vectors corresponding to a plurality of second time delay hypotheses placed relative to the plurality of first time delay hypotheses, each code phase discriminator vector being based on estimated signal processing, filtering, and noise characteristics of the received ranging signal for a respective second time delay hypothesis; and determining, by the receiver, a second estimated TOA of the received ranging signal using the correlator vector and the plurality of code phase discriminator vectors, the second estimated TOA being a more accurate estimate of the actual TOA of the received ranging signal as compared to the first estimated TOA.

In some aspects, the techniques described herein relate to a method, including: receiving, at a receiver, a ranging signal from a transmitter, the ranging signal including a reference sequence; generating, by the receiver, a filtered ranging signal using the received ranging signal; estimating, by the receiver using the filtered ranging signal, a first estimated time of arrival (TOA) of the received ranging signal; generating, by the receiver, a filtered local replica of the received ranging signal; determining, by the receiver, a plurality of first time delay hypotheses of an actual TOA of the received ranging signal; segmenting, by the receiver, the filtered ranging signal into a plurality of time bins, each time bin corresponding to a short duration in which a timing drift of the received ranging signal is negligible, and each time bin being associated with a respective amount of timing drift; generating, by the receiver, a correlator vector using the filtered ranging signal, the filtered local replica of the ranging signal, and the plurality of first time delay hypotheses; generating, by the receiver, a plurality of code phase discriminator vectors corresponding to a plurality of second time delay hypotheses; adjusting, by the receiver, the plurality of code phase discriminator vectors for each time bin based on an observed timing drift from previous time bins; projecting for each time bin, by the receiver, for each second time delay hypothesis, a corresponding adjusted code phase discriminator vector onto the correlator vector to generate a corresponding binned weighted sum; for each second time delay hypothesis, accumulating, by the receiver, the binned weighted sums over the plurality of time bins; maximizing a square or a magnitude of the accumulated weighted sums; and generating, by the receiver, a second estimated TOA using a second time delay hypothesis that is associated with a maximum accumulated weighted sum, the second estimated TOA being a more accurate estimate of the actual TOA of the received ranging signal as compared to the first estimated TOA.

In some aspects, the techniques described herein relate to a method, including: receiving, at a receiver, a ranging signal from a transmitter, the ranging signal including a reference sequence; generating, by the receiver, a plurality of time-segmented correlator vectors based on the received ranging signal and a plurality of first time delay hypotheses, each time segment representing a duration over which a complex amplitude and phase of the received ranging signal are independent of one another; generating, by the receiver, a correlator covariance matrix of the plurality of time-segmented correlator vectors; generating, by the receiver, a plurality of second time delay hypotheses for the received ranging signal; generating, by the receiver, a plurality of code phase discriminators corresponding to the plurality of second time delay hypotheses; projecting, by the receiver, for each second time delay hypothesis, a corresponding code phase discriminator vector onto the correlator covariance matrix; maximizing a square or a magnitude of the projection onto the correlator covariance matrix; and generating, by the receiver, an estimated time of arrival (TOA) of the received ranging signal using a second time delay hypothesis that is associated with a maximum of the projection onto the covariance matrix.

In some aspects, the techniques described herein relate to a method, including: receiving a ranging signal from a transmitter; correcting for Doppler and frequency offset of the received ranging signal; determining a first estimated time of arrival (TOA) which is an approximate TOA estimate of the ranging signal; computing M correlators around the approximate TOA using the received ranging signal; and determining a second estimated TOA of the received ranging signal by performing Maximum Likelihood interpolation of the M correlators, the second estimated TOA being a more accurate TOA estimate than the first estimated TOA.

### BRIEF DESCRIPTION OF THE DRAWINGS

FIG. 1 shows an example of an operational environment for position estimation of a mobile device using a Maximum Likelihood code phase discriminator, in accordance with some embodiments.

FIG. 2 is a simplified portion of an example process for position estimation using a Maximum Likelihood code phase discriminator, in accordance with some embodiments.

FIGS. 3A-3B show simplified graphs of an autocorrelation function of a received ranging signal and correlator positioning examples, in accordance with some embodiments.

FIG. 4 shows simplified examples of several code phase discriminator types, in accordance with some embodiments.

FIGS. 5-9 show simplified graphs illustrating aspects of a Maximum Likelihood code phase discriminator, in accordance with some embodiments.

FIGS. 10A-10C show simplified graphs illustrating simulation results of a Maximum Likelihood code phase discriminator, in accordance with some embodiments.

FIG. 11 illustrates the components of a transmitter, a mobile device, and a server, in accordance with some embodiments.

### DETAILED DESCRIPTION

An estimated location of a mobile device may be determined using time of arrival (TOA) estimates of wireless signals (“ranging signals”) received at the mobile device. The ranging signals may originate from either terrestrial transmitters (e.g., a wide area position system) or non-terrestrial transmitters (e.g., satellites) located at known positions. Attributes of the received signals may then be used by the mobile device to perform trilateration, as is well understood in the art. As part of trilateration, a ranging signal receiver (“receiver”), e.g., at the mobile device, typically performs an acquisition stage where it first searches for a ranging signal transmitter until it detects it, and then finds a coarse signal time of arrival (TOA) (i.e., a coarse code phase) and a coarse Doppler estimate. Afterwards, the receiver goes into a tracking stage where it fine-tunes the estimated TOA (“code phase”) and Doppler estimate and then continues tracking the code phase. After sudden changes in the environment, such as a receiver in a vehicle making a turn around a building, the tracking stage needs to quickly retune the code phase and Doppler. Continued optimization of a receiver chain within a mobile device may lead to various benefits such as reducing power consumption and improving reactivity to sudden changes as a vehicle moves around objects.

An estimated TOA is also known as code phase in some forms of wireless signal trilateration. In order to fine-tune a coarse code phase, the receiver typically computes a few correlators surrounding an initial guess and then adjusts their timing until the receiver locates the peak of the correlation. Each correlation is generated using the received ranging signal and a local replica of the transmitted signal. The correlators in the receiver are often denoted by Early, Prompt, and Late correlators (EPL correlators) and are sometimes augmented by more correlators such as Very-Early or Very-Late correlators. In each case, the spacing between correlators can be specified in different ways, e.g., a wide spacing of 0.5 chips between adjacent correlators, or a narrow spacing of 0.125 chips between adjacent correlators. A “chip” is a pulse or fundamental unit of transmission in a digital communication system that uses spread spectrum codes, such as pseudo-random noise (PRN) code sequences.

Conventional code phase discriminators (e.g., such as those used in GNSS systems) that convert from EPL correlator values to an accurate code phase tend to use heuristics and are suboptimal. In such conventional solutions, the Prompt correlator, containing the most energy, tends to be discarded which leads to a decrease in performance, especially in noisy environments. For example, a conventional normalized code phase discriminator, after aligning with the Prompt correlator's In-phase (I) component, is given by

$$\frac{( {I}_{E} - {I}_{L} )}{{I}_{P}} , \qquad ( Equation 1 )$$

where the indices E, P, and L correspond to the EPL correlators, respectively. The Quadrature (Q) component can be neglected after the alignment. In such examples, the formula depends essentially on I_{E}−I_{L} and the Prompt correlator is merely used for power level normalization.

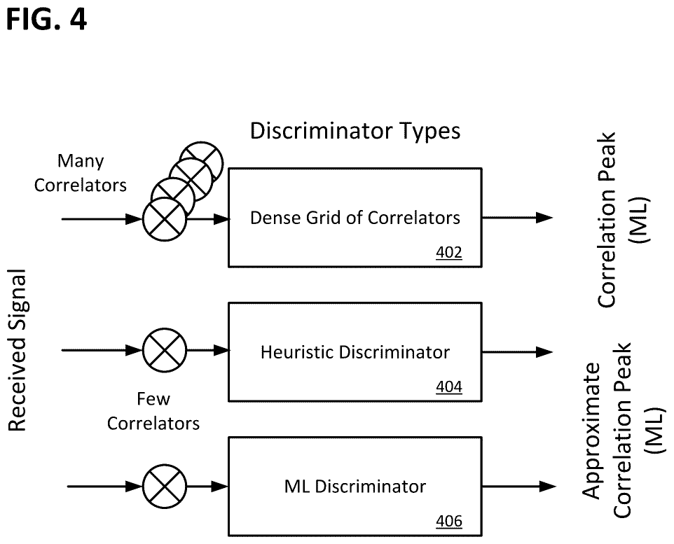

In such systems, the code phase discriminator is often employed inside a Delay-Locked Loop (DLL), and is also referred to as a “DLL discriminator” or “code loop discriminator.” Simplified examples of code phase discriminator types are illustrated in FIG. 4 and described below. One conventional code phase discriminator implementation uses a dense set of correlators, i.e., a grid of narrowly spaced correlators, and then picks the strongest one, optionally using interpolation of adjacent correlators from the grid. However, such solutions are costly due to the number of correlators to be computed on the grid.

Other conventional code phase discriminators may use fitting to the autocorrelation function or may apply a time delay via Sinc interpolation. The fitting of the correlators to the autocorrelation function may be achieved by sliding the autocorrelation function until it best fits the estimated correlators, e.g., using Least Squares. The timing of the best fit determines the code phase. However, these solutions are suboptimal from the point of view of the Maximum Likelihood (ML) criterion as the pre-computed correlators contain correlated noise (colored noise). Indeed, what is needed is a Weighted Least Squares where the weights matrix is carefully computed to account for noise coloring.

Applying a time delay to the correlators, using Sinc interpolation until the peak is found, is also suboptimal unless, a) a sufficient number of additional correlators are used on each side of the EPL correlators, and b) the number of in-between correlators is increased, or correlator spacing is reduced to reach the Nyquist sampling rate. Therefore, a large number of correlators are conventionally needed to reach the ML solution.

Disclosed herein is a Maximum Likelihood code phase discriminator that advantageously converts the EPL correlators, or any set of correlators having any spacings, to a code phase estimate in an efficient manner against noise and other distortions or shaping. As shown by the simulation results discussed herein, the Maximum Likelihood code phase discriminator generally converges faster than conventional solutions, despite using a limited number of correlators.

Solutions for both coherent and non-coherent correlations are additionally disclosed herein. Still additionally, a solution for drifting correlators due to fast satellite movement or large receiver clock errors is described herein. Still yet additionally, a solution for the impact of the different Pseudo-random noise (PRN) sequences on the code phase discriminator due to small differences in their autocorrelation function is disclosed herein.

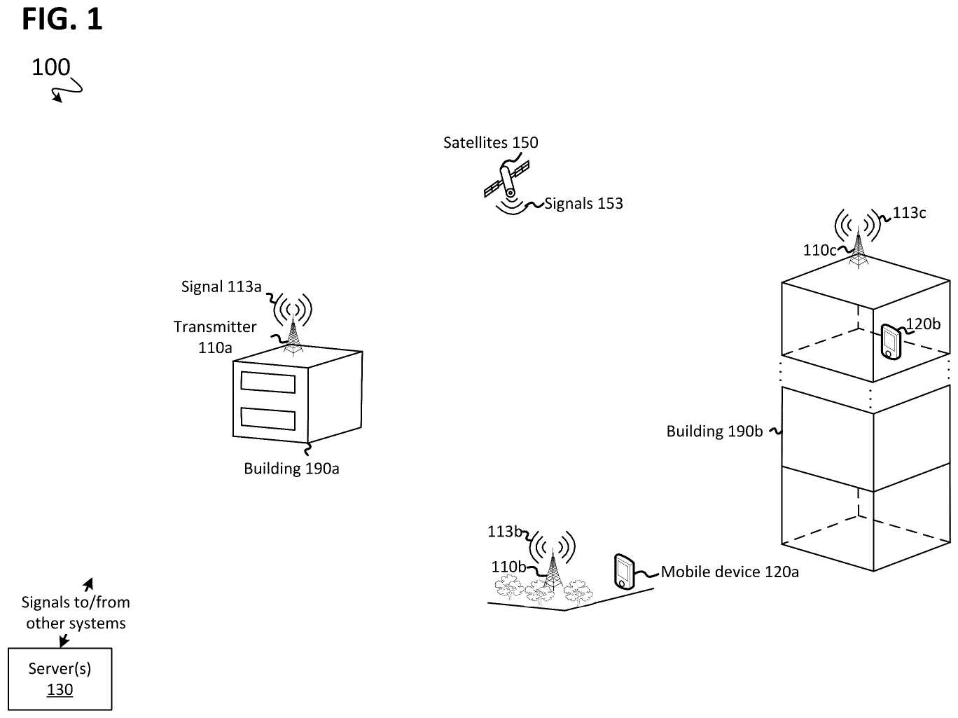

Attention is initially drawn to an operational environment 100 for a mobile device in FIG. 1, in accordance with some embodiments. The operational environment 100 contains a network of terrestrial transmitters 110a-c, any number of mobile devices 120a-b, any number of buildings 190a-b, any number of satellites 150, and any number of servers 130. Also shown are signals 113a-c associated with the respective transmitters 110a-c, and signals 153 associated with the satellites 150.

The transmitters 110a-c and the mobile devices 120a-b may be located at different altitudes or depths that are inside or outside various natural or manmade structures (e.g., the buildings 190a-b). The signals 113a-c and 153 are exchanged between the mobile devices 120a-b, the transmitters 110a-c, and the satellites 150 using known wireless or wired transmission technologies. The transmitters 110a-c may transmit the signals 113a-c using one or more common multiplexing parameters—e.g., time slot, pseudorandom sequence, or frequency offset. The servers 130 and the mobile devices 120a-b may exchange information with each other.

The satellites 150 may be part of a GNSS (Global Navigation Satellite System) which may include other existing satellite positioning systems such as Glonass as well as future positioning systems such as Galileo and Compass/Beidou. The transmitters 110a-c may be synchronized beacons of a wide area positioning system and may form a CDMA network. Each of the transmitters 110a-c may be operable to transmit a Pseudo Random Number (PRN) sequence with good cross-correlation properties such as a Gold Code sequence with a data stream of embedded assistance data. Alternatively, wireless signals transmitted by the transmitters 110a-c may be staggered in time into separate slots in a TDMA format. The mobile devices 120a-b are operable to receive ranging signals using a wireless position signal receiver and to determine an estimated 2D or 3D position thereof based on time of arrival estimates of the received signal using a Maximum Likelihood code phase discriminator disclosed herein.

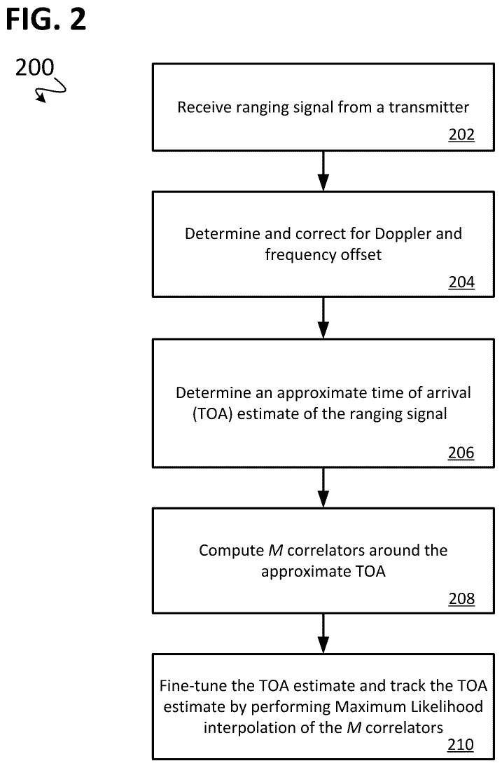

FIG. 2 is a simplified portion of an example process for position estimation using a Maximum Likelihood code phase discriminator, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 202, one or more ranging signals are received by a receiver at a mobile device from a ranging signal transmitter (e.g., the transmitters 110a-c and/or the satellites 150 shown in FIG. 1). At step 204, frequency offset and Doppler of the received ranging signal are determined and corrected for at the receiver (i.e., to generate a filtered received ranging signal). At step 206, a coarse time of arrival (TOA) estimate is determined at the receiver (i.e., a first time of arrival estimate). At step 208, M correlators, where M is a value greater than or equal to one, are computed at time offsets surrounding the approximate TOA. At step 210, another (i.e., a second) TOA estimate is found using a Maximum Likelihood code phase discriminator to perform interpolation of the M correlators at a higher accuracy than the approximate TOA. The code phase is tracked thereafter.

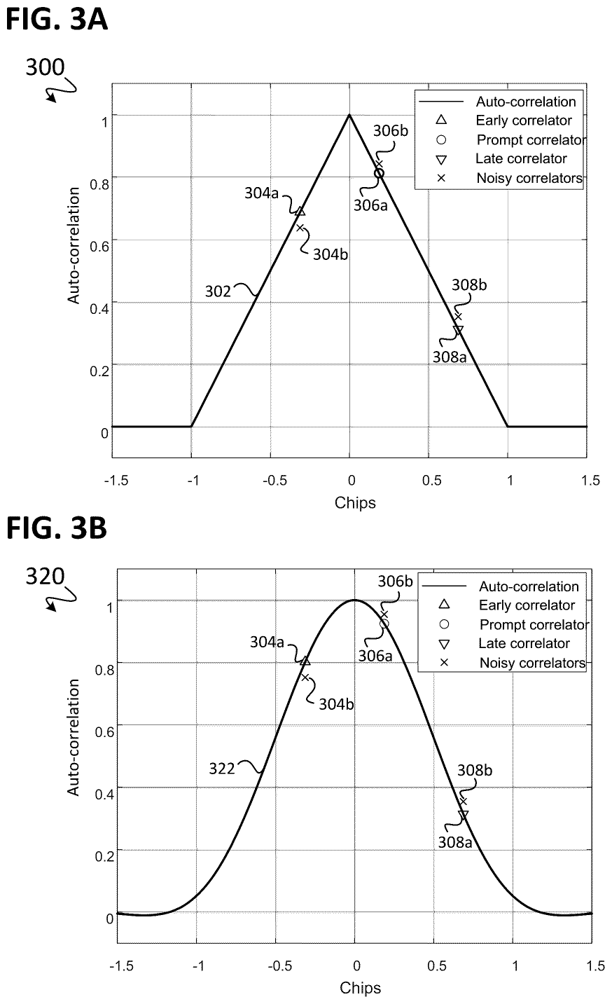

FIGS. 3A-B show simplified graphs 300 and 320 of an autocorrelation function of a received ranging signal and various correlator positioning examples, in accordance with some embodiments. FIG. 3A shows the simplified graph 300 of an autocorrelation function 302 of a received ranging signal over a range of chips. Example ideal correlators 304a, 306a, and 308a (i.e., in an absence of noise) lie on the autocorrelation function 302 having infinite bandwidth, whereas examples of correlators 304b, 306b, and 308b, subject to noise, are slightly offset from the autocorrelation function 302. The simplified graph 320 of FIG. 3B shows the correlators 304a-b, 306a-b, and 308a-b that were introduced in FIG. 3A, however an autocorrelation function 322 is an example of an autocorrelation function generated using a narrower bandwidth as compared to that of 302 (i.e., it has been lowpass filtered).

To simplify the description of the Maximum Likelihood code phase discriminator, it is assumed that the boundary of any modulating data bits has been detected, and the modulating data bits and frequency offset have been wiped off in order to carry coherent correlation (e.g., as part of step 202 or 204 of FIG. 2). Correlation is performed over a number of codes (i.e., accumulating or integrating after PRN sequence wipe-off), where each code is 1 ms to 10 ms in typical GNSS solutions, and where the accumulation can be over 1 ms to more than 1 second, for example. Then, e.g., as part of step 208 of FIG. 2, one or more correlators are computed around an approximate TOA of the ranging signal.

At this point, as shown in FIG. 3A, one or more correlators (e.g., 304a/b, 306a/b, and 308a/b) are generated. The correlators 304a/b are examples of an Early correlator. The correlators 306a/b are examples of a Prompt correlator, and likewise, the correlators 308a/b are examples of a Late correlator. The autocorrelation function 302 may usually have a triangular shape if the bandwidth is wide and the sampling rate is high. However, as shown in FIG. 3B, the autocorrelation function 322 assumes a non-triangular shape when lowpass filtering is applied and a narrower bandwidth, e.g., 2 to 4 MHz is used. The shape of the autocorrelation function, the bandwidth, and the sampling rate of the signal are given only for illustration.

The ideal noise-free correlators 304a, 306a, and 308a lie on top of the autocorrelation functions 302/322, with some unknown time offset relative to time 0, where the unknown time offset is to be efficiently determined by the proposed solution.

The ML code phase discriminator disclosed herein advantageously finds a best fit given any number of correlators that are positioned at any place or spacing with respect to each other, and by taking into account what happened in the resampling, filtering, and correlation stages before the code phase discriminator stage is reached. The ML code phase discriminator additionally takes into account the filtering and noise coloring, as well as the correlation between the correlators.

The ML code phase discriminator is particularly useful for the GNSS L5 band where each correlator is quite costly to compute, i.e., where the bandwidth over chip rate is relatively low, resulting in a non-triangular shape of the correlation function, and where the correlator spacing, measured in meters, is small, resulting in higher sensitivity to fast changes in the environment. In practice, a spacing of 0.5 chips for GPS L1 C/A is about 150 meters, while 0.5 chips for GPS L5 is about 15 meters.

FIG. 4 provides examples of several code phase discriminator types 402, 404, and 406, in accordance with some embodiments. The code phase discriminators 402 and 404 are examples of conventional code phase discriminators, whereas the code phase discriminator 406 is the ML code phase discriminator disclosed herein.

The output of the code phase discriminator 402 is an overall, or final, ML solution (assuming an infinitely dense grid, or very dense grid of correlators). By comparison, the respective outputs of the code phase discriminators 404 and 406 are an approximation. Each of the code phase discriminators 402, 404, and 406 receives a ranging signal and produces a correlation peak, which may be an ML solution. However, the conventional code phase discriminators 402 and 404 reach the ML solution at a greater computational expense and time as compared to the ML code phase discriminator 406. Furthermore, in some scenarios, the conventional code phase discriminators 402 and 404 may not even reach the ML solution, if for example there are rapid changes in the environment.

To elaborate, the code phase discriminator 402 uses a large number of correlators to optimally reach the overall ML solution without any intermediate stage, but at a great computational burden. The code phase discriminator 404 uses fewer correlators as compared to the code phase discriminator 402 and employs a heuristic approach (e.g., a search loop is performed over time). The heuristic approach of the code phase discriminator 404 may eventually converge to the overall ML solution (a correlation peak), however, the convergence is slow and it is suboptimal against noise. It may miss the correlation peak in difficult environments.

As disclosed herein, such a heuristic approach is replaced by an ML code phase discriminator 406. The ML code phase discriminator 406 speeds up and improves convergence as compared to the code phase discriminators 402 and 404, particularly in difficult conditions. The ML code phase discriminator employs an intermediate ML stage to approximately and efficiently reach the final ML solution.

### Mathematical Formulation

The following notion is used herein. Scalars (a) are given in italics, small or capital. Vectors (v) are in bold small letters. Matrices (A) are in bold capital letters. Unless otherwise indicated, vectors are of size N, and matrices are square of size N×N, where N is the time or frequency space dimension, e.g., the length of one oversampled code (e.g., in GPS: a 1 ms code is 1023 chips, and can be oversampled by 16 to N=16368 samples). As the time and frequency domains are a simple change of basis, a vector or matrix is denoted by the same label whether it is represented in the time or frequency domain. Clarifications are made when necessary. By default, vectors and matrices of size N and N×N, respectively, are assumed to be in the frequency domain for simplicity. After projection on the smaller subspace of the correlators, of size M≤N, the vectors and matrices are expressed in the time domain. Hence, vectors of size M and matrices of size M×M are given in the time domain. However, some vectors and matrices in both the time domain and frequency domain disclosed may be of differing sizes.

A circulant matrix is defined by its first row. For vectors a, v and corresponding matrices A=diag (a), V=diag (v), or A=circulant (a), V=circulant (v), Av=Va is an identity that denotes the commutative correlation or convolution. A circular convolution or correlation is performed via the matrix by vector multiplication Av=Va. A circular convolution in the time domain uses the circulant matrix, and the corresponding convolution in the frequency domain uses the diagonal matrix.

A usual circular convolution u=Av has the elements uₖ=a_{k,k}vₖ in the frequency domain, or uₙ=Σⱼ a_{n,j} vⱼ in the time domain, where uₓ, vₓ, a_{x,y} are the elements of the vectors u, v and matrix A respectively, either expressed in the frequency domain or in the time domain. In these equations, the indices k, n, and j serve distinct roles. The index k is used to reference individual elements in the frequency domain, where uₖ denotes the k^{th} element of the frequency-domain vector u, and νₖ represents the corresponding k^{th} element of vector v. In this context, a_{k,k} is the element on the k^{th} row and k^{th} column of the matrix A, specifically in the frequency domain. Conversely, in the time domain, n represents the position within vector u, with uₙ indicating the n^{th} element. The summation index j iterates over the elements of vector v and the corresponding row in matrix A, where a_{n,j} is the element at the intersection of the n^{th} row and j^{th} column in the time domain.

In the foregoing example, in the time domain, A is circulant. Therefore, in the time domain, its elements per row are circularly shifted relative to a previous row, or the first row: a_{n,j}=a_{0,(j-n modulo N)}, where the first row is indicated with an index of 0. The last row a_{N-1,j} is the flipped vector a corresponding to circular convolution with A, which is also the inverse Fourier transform of the diagonal of A in the frequency domain. The first row is one element circularly shifted to the right of the last row.

A matrix and vector represented by the same letter correspond to: X=diag (x) in the frequency domain, or X=circulant (x) in the time domain. For two vectors, x, p, the convolution commutativity can be written as: Px=Xp, or correlation commutativity as P^{H}x=X^{H}p, where superscript H denotes the Hermitian vector or matrix (complex conjugate and transpose).

The vector elementwise product is denoted by ⊙. Diagonal matrices may be expressed in the frequency domain such that XH=diag (x⊙h) and X^{H}X=diag (x*⊙x), where superscript T indicates matrix transpose, and superscript * indicates matrix complex conjugate (without transpose). The ⊙ operation in the time domain can be viewed as the convolution of two vectors. Trace (X) is the sum of the diagonal elements of matrix X, and the sum (x) is defined as the sum of the elements of vector x. The vector elementwise division is denoted by Ø. Then for diagonal matrices, C⁻¹X=diag (xØ c). It is straightforward to extend the ⊙ and Ø operations to the case of vector times matrix as may be done in MATLAB.

In the frequency domain, the phase ramp vector of time delay t is

$${p}_{t} = \frac{1}{\sqrt{N}} {( … , {e}^{- j 2 π kt} , … )}^{T} , \qquad ( Equation 2 )$$

with elements for k varying from 0 to N−1. In the time domain, it corresponds to a time shift, i.e., a Sinc function delayed by t. Matrix Pₜ≙diag (pₜ) in the frequency domain (or circulant of pₜ in the time domain).

The matrix F_{t̅} is a matrix of M≤N horizontally concatenated phase ramp vectors p_{δt}_{ᵢ}, for M time instants or hypotheses αₜ_{ᵢ}, where i varies from 0 to M−1. The set t̅ is such that dot δₜ_{ᵢ} Σt̅. F_{t̅} is of size N×M. F_{t̅}^{H} applied to a vector computes an inverse DFT (Discrete Fourier Transform), or Sinc interpolation, for the M specified delays; the output vector of size M is given in the time domain.

As described below, F_{t̅}^{H} enables outputting the correlation value for a set of M samples, with carefully selected timing in t̅, e.g., Early, Prompt, and Late correlators that surround the true but unknown code phase, δtᵤ (M=3 correlators in this example). The set t̅ is generally determined based on an initial stage of searching for the ranging signal, or acquisition stage, that determines roughly where the time of arrival δtᵤ is located, in order to place the correlators surrounding δtᵤ.

A small delta time delay around some time reference t_{ref} is denoted as δtᵢ, where t_{ref} is known and based on current coarse knowledge of the timing (e.g., the coarse code phase following the acquisition stage). The value of t_{ref} can be set to the timing of the Prompt correlator, or earliest correlator, or any timing in the vicinity of the set t of the correlator's timings.

The model of the received signal in GNSS is defined as

$$y = {a}_{u} H {P}_{δ {t}_{u}} x + n \qquad ( Equation 3 a )$$

$$= {a}_{u} H X {p}_{δ {t}_{u}} + n , \qquad ( Equation 3 b )$$

$$Ly {=}^{Δ} {a}_{u} \overline{X} {p}_{δ {t}_{u}} + L n , \qquad ( Equation 3 c )$$

where x is the transmitted reference vector often consisting of the PRN chip sequence (i.e., a reference sequence) for one code, e.g., 1 ms, shaped with, e.g., binary phase-shift keying (BPSK) or binary offset carrier modulation (BOC), and oversampled, e.g., to 16.368 Msps. The bandwidth of this vector in the frequency domain could be equal to the sampling rate, e.g., 16.368 MHz, or it could be band-limited to below the sampling frequency via low-pass filtering.

P_{δt}_{ᵤ} applies the delta time delay δtᵤ, which is the “unknown” TOA (relative to the known t_{ref}, i.e., it is assumed that the timing is translated to t_{ref}, and the remaining unknown timing is only a small delta time). The unknown TOA δtᵤ is to be estimated using the ML code phase discriminator process disclosed herein. H models the filtering and resampling operations. The filtering operation may include analog RF filtering, digital baseband filtering, filtering for interference (e.g., notch filter), etc. In the frequency domain, it is often the case that H=diag (h). The complex scalar aᵤ of the signal's amplitude and phase is “unknown” and the model assumes a unique path from transmitter to receiver, e.g., the Line-of-Sight (LoS) path. The parameter n is the noise vector with noise covariance matrix C, which is often a diagonal matrix in frequency domain C=diag (c), and that may model (shaped) noise and interference levels as a function of frequency after various filtering and resampling stages. The noise is assumed to be Gaussian. Thus, the matrix X̅ is a referred to herein as “transformation matrix” that models signal distortions caused by the filtering and resampling of the received ranging signal, among other parameters. The parameter y is the observation vector of size N×1.

Given that the matrices are diagonal in the frequency domain or circulant in the time domain, the roles of x and p_{δt}_{ᵤ} may be reordered via commutativity.

The Cholesky decomposition LCL^{H} ≙I_{N}, or L^{H}L=C⁻¹ may be used for convenience, where I_{N} is the identity matrix (N×N). The noise whitening matrix L may be applied in Equation 3C. Additionally, the filtered and noise-whitened reference vector may be defined as X̅≙LHX.

The ML estimator for a final ML solution, such as that of the code phase discriminator 402 shown in FIG. 4 may be obtained by minimizing

$${min}_{a ′ , t ′} {( Ly - {a}^{′} \overline{X} {p}_{δ t ′} )}^{H} ( L y - {a}^{′} \overline{X} {p}_{δ t ′} ) \qquad ( Equation 4 )$$

over scalar hypotheses a′ of the signal amplitude and phase, and time of arrival hypotheses δt′. Given a time of arrival hypothesis on δt′, the ML estimator is found for the complex scalar a′ by differentiating to obtain,

$${\hat{a}}_{δ t ′} = {\hat{σ}}_{δ t ′}^{2} {p}_{δ t ′}^{H} {\overline{X}}^{H} Ly , \qquad ( Equation 5 )$$

$$with$$

$${\hat{σ}}_{δ t ′}^{2} {=}^{Δ} 1 / ( {p}_{δ t ′}^{H} {\overline{X}}^{H} \overline{X} {p}_{δ t ′} ) \qquad ( Equation 6 )$$

being the noise variance after projection. By writing p_{δt′}=P_{δt′}1_{N}, where 1_{N} is the all ones vector of size N and normalized by \sqrt{N}, commutativity may be applied to find:

$${\hat{σ}}_{δ t ′}^{2} = 1 / ( {1}_{N}^{H} {X}^{H} X {H}^{H} H {C}^{- 1} {1}_{N} ) = {\hat{σ}}^{2} , \qquad ( Equation 7 )$$

which is a constant independent of the time of arrival hypotheses δt′. It is also given by

$${\hat{σ}}^{2} = 1 / trace ( {X}^{H} X {H}^{H} H {C}^{- 1} ) . \qquad ( Equation 8 )$$

The estimate of the unknown TOA is given by maximizing the output Signal-to-Noise Ratio (SNR) (times a constant),

$$, \frac{{\vert {\hat{a}}_{δ t ′} \vert}^{2}}{{\hat{σ}}^{2}} , i . e . ,$$

$${\hat{t}}_{c} = arg {max}_{δ t ′} ( {\hat{σ}}^{2} {\vert {p}_{δ t ′}^{H} {\overline{X}}^{H} Ly \vert}^{2} ) . \qquad ( Equation 9 )$$

A search over the TOA hypotheses δt′ is performed until the formula is maximized. For a given TOA hypothesis δt′, the output of the inner formula before squaring, r_{δt′}≙p_{δt′}X̅^{H}Ly, is in fact a typical coherent correlator computed in GNSS receivers, such as any of the EPL correlators.

In conventional GNSS receivers, the filtering and resampling operation H, and the noise covariance matrix C, are often neglected, resulting in the simplified correlation p_{δt′}^{H} X^{H}y, where p_{δt′}^{H} applies the time delay for a given correlator, and X^{H} applies the PRN wipe-off. Although in conventional GNSS receivers, the code phase discriminator may eventually converge to the above ML solution, or correlation peak, the “search over TOA hypotheses δt′ based on pre-computed correlators” uses heuristics that converge slowly or suboptimally, and may sometimes miss the correlation peak. The ML code phase discriminator disclosed herein replaces such heuristics with a Maximum Likelihood search that speeds up and improves convergence, particularly in difficult conditions.

### Maximum Likelihood Interpolation of the Correlators

Having reduced the search space to a few correlators (e.g., such as in the code phase discriminator 406), the Maximum Likelihood code phase discriminator disclosed herein may be used to avoid searching over a large number of TOA hypotheses δt′ in Equation 9. Additionally, the M correlators r_{δt′} may be concatenated into a correlation vector. This is done by replacing the one projection vector p_{δt′} by M projection vectors with timings in the set t̅, i.e., by applying the matrix F_{t̅} of horizontally concatenated phase ramp vectors. As such, the following M×1 correlation vector is obtained:

$${r}_{\overline{t}} {=}^{Δ} {F}_{\overline{t}}^{H} {\overline{X}}^{H} Ly . \qquad ( Equation 10 )$$

Ideally, the set t̅ is carefully selected to cover most of the correlation energy. Then the vector r_{t̅} represents roughly the original signal in a reduced subspace (or compressed subspace).

The traditional goal in GNSS is to slowly converge from the set t̅ toward δ\hat{t}ᵤ, via several iterations, often by ensuring that the Early and Late correlators in the set t̅ are balanced, i.e., having equal power, such that indirectly the Prompt correlator has possibly reached the peak of the correlation. In contrast, a goal of the ML code phase discriminator disclosed herein is to find δ\hat{t}ᵤ from the first iteration; or using a few iterations. This means faster convergence and faster reactivity to changes in speed or environment. Additionally, as disclosed herein, all correlators in the set t̅ are advantageously taken into account, especially the strongest correlator such as the Prompt correlator, rather than ignoring its value as is often done in the current state of the art. Still additionally, the correlators and noise coloring that result from the first correlation operation, X^{H}y are taken into account by the ML code phase discriminator disclosed herein. Noise coloring means stronger noise in a certain direction and therefore the best solution may be to steer away from the strong noise direction.

For this, the statistical model of r_{t̅} is found in the reduced subspace by replacing the value of Ly in Equation 10 with the expression defined in Equation 3c to arrive at

$${r}_{\overline{t}} = {F}_{\overline{t}}^{H} {\overline{X}}^{H} ( {a}_{u} \overline{X} {p}_{δ {t}_{u}} + L n ) \qquad ( Equation 11 a )$$

$$= {a}_{u} {F}_{\overline{t}}^{H} {\overline{X}}^{H} \overline{X} {p}_{δ {t}_{u}} + {F}_{\overline{t}}^{H} {\overline{X}}^{H} L n \qquad ( Equation 11 b )$$

Therefore, the vector of correlators that is typically computed in GNSS consists of a delayed Sinc or phase ramp p_{δt}_{ᵤ}, with unknown time delay δtᵤ to be determined, shaped by X̅^{H}X̅, sampled in the time domain via F_{t̅}^{H} at the correlator's timings in the small set t̅, and with additive noise having covariance matrix:

$${C}_{r} = {F}_{\overline{t}}^{H} {\overline{X}}^{H} \overline{X} {F}_{\overline{t}} \qquad ( Equation 12 a )$$

$$= {F}_{\overline{t}}^{H} {X}^{H} X {H}^{H} H {C}^{- 1} {F}_{\overline{t}} . \qquad ( Equation 12 b )$$

The commutatively reordered version holds only if the matrices are diagonal in the frequency domain. Matrix Cᵣ is of size M×M. In the case of GNSS, post correlations, the matrix Cᵣ is generally a colored noise matrix, non-diagonal, and non-circulant. When solving for the ML solution, in order to find δtᵤ, it is important to consider the noise coloring in Cᵣ for the best performance.

As the vector of observations y is replaced by a compressed vector of post-processed observations, or correlations, an important aspect is to ensure that r_{t̅} contains most of the information available in y. This can be done by ensuring that r_{t̅} contains most of the signal energy in y. At chip spacing of 0.5, there is usually a need for about four correlators to capture most of the useful energy in y as long as the receiver is not yet synched to δtᵤ. After the receiver is synched, three correlators can capture most of the energy; nevertheless, any sudden changes in the environment might require a fourth and fifth correlator to capture most of the energy after such changes. Correlator spacing matching the Nyquist sampling rate is also needed to cover most of the energy in the bandwidth; but the loss tends to be small for correlator spacing of 0.5 chips for GPS L1 C/A, as most of the energy is present within 2.046 MHz.

The ML estimate of δ\hat{t}ᵤ given r_{t̅} and Cᵣ is, as before, obtained by projecting onto the reference signal with various discrete delta time hypotheses δt′, after noise whitening. Only this time, the vectors are of size M<<N, hence the problem's complexity is far lower and may be expressed as,

$${σ}_{r , δ t ′}^{2} {=}^{Δ} \frac{1}{{p}_{δ {t}^{′}}^{H} {\overline{X}}^{H} \overline{X} {F}_{\overline{t}} {C}_{r}^{- 1} {F}_{\overline{t}}^{H} {\overline{X}}^{H} \overline{X} {p}_{δ {t}^{′}}} , \qquad ( Equation 13 a )$$

$${\hat{a}}_{δ t ′} = {σ}_{r , δ t ′}^{2} {p}_{δ t ′}^{H} {\overline{X}}^{H} \overline{X} {F}_{\overline{t}} {C}_{r}^{- 1} {r}_{\overline{t}} , \qquad ( Equation 13 b )$$

$$δ {\hat{t}}_{u} = {arg max}_{δ t ′} {σ}_{r , δ t ′}^{2} {\vert {p}_{δ t ′}^{H} {\overline{X}}^{H} \overline{X} {F}_{\overline{t}} {C}_{r}^{- 1} {r}_{\overline{t}} \vert}^{2} , \qquad ( Equation 13 c )$$

where σ_{r, δ t′}² is the output noise variance after projection. In this case, it is dependent on the delta time hypothesis δt′.

The time hypotheses projection vectors, or code phase discriminator vectors, of size M×1 are defined as,

$$\begin{matrix}{v}_{δ t ′} & {=}^{Δ} & {σ}_{r , δ {t}^{′}} {C}_{r}^{- 1} {F}_{\overline{t}}^{H} {\overline{X}}^{H} \overline{X} {p}_{δ {t}^{′}} & ( Equation 14 a ) \\ & = & {{σ}_{r , δ t ′} ( {F}_{\overline{t}}^{H} {\overline{X}}^{H} \overline{X} {F}_{\overline{t}} )}^{- 1} {F}_{\overline{t}}^{H} {\overline{X}}^{H} \overline{X} {p}_{δ t ′} . & ( Equation 14 b ) \\ & & & \end{matrix}$$

The time hypothesis projection vectors may be advantageously precomputed offline, and stored in memory, for example, for a fine grid delta time hypotheses δt′ that covers the expected uncertainty range in the region of t̅. For instance, the fine grid can extend from −0.5 to +0.5 of a chip around the Prompt correlator. The grid spacing or resolution is of the order of 1/100 of a chip for accuracy near 1 meter. In some embodiments, one or more fine delta time hypotheses may be associated with a time that is earlier than an earliest correlator. Similarly, in some embodiments, one or more fine delta time hypotheses may be associated with a time that is later than a latest correlator. In some embodiments, one or more fine delta time hypotheses may be associated with a time that is between two of the correlators (e.g., between an Early and Prompt correlator, or between a Prompt and Late correlator).

In computer programming, matrix multiplication may be replaced by vector elementwise multiplication for the quantity X̅^{H}X̅F_{t̅}=x*⊙x⊙h*⊙hØ c⊙F_{t̅}. The vectors are normally real (i.e., non-complex). Hence, Equation 13c simplifies to,

$$δ {\hat{t}}_{u} = arg {max}_{δ t ′} {\vert {v}_{δ t ′}^{H} {r}_{\overline{t}} \vert}^{2} . \qquad ( Equation 15 )$$

In short, the correlators vector, r_{t̅}, is projected onto a list of code phase discriminator vectors, selected on a fine grid, and the strongest projection is selected to obtain the fine TOA, δ\hat{t}ᵤ which is a more accurate estimate of the actual time of arrival of the received ranging signal as compared to the coarse signal time of arrival previously acquired. The corresponding SNR is proportional to â_{δt}_{ᵤ}, which is obtained from Equation 13b.

An important observation is that for any p_{δt′} that satisfies the linear combination p_{δt′}=F_{t̅}Φ_{M}, where Φ_{M} is an M×1 vector generating a linear combination of F_{t̅}, the following holds

$$\begin{matrix}{v}_{δ t ′} & = & {{σ}_{r , δ t ′} ( {F}_{\overline{t}}^{H} {\overline{X}}^{H} \overline{X} {F}_{\overline{t}} )}^{- 1} {F}_{\overline{t}}^{H} {\overline{X}}^{H} \overline{X} ( {F}_{\overline{t}} {Φ}_{M} ) & ( Equation 16 a ) \\ & = & {σ}_{r , δ t ′} {Φ}_{M} , & ( Equation 16 b ) \\ & & & \end{matrix}$$

$$and$$

$${σ}_{r , δ t ′}^{2} = 1 / {‖ {Φ}_{M} ‖}^{2} . \qquad ( Equation 17 )$$

$$Therefore ,$$

$${v}_{δ t ′} = {Φ}_{M} / ‖ {Φ}_{M} ‖ . \qquad ( Equation 18 )$$

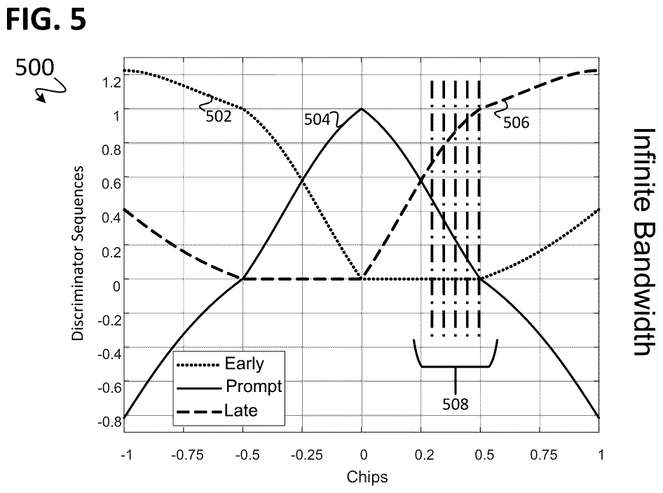

In particular, for any δtᵢ∈t̅, the linear combination holds and v_{δt}_{ᵢ} is an all-zeros vector, except 1 for the coordinate of the correlator at δtᵢ. This is an expected result since if a correlator is placed precisely where a correlation peak is expected, the correlation output is the value of this correlator and is independent of the other correlators. For example, a simplified graph 500 of FIG. 5 illustrates code phase discrimination vectors v_{δt′} as a function of δt′ for BPSK modulation with infinite bandwidth. The graph 500 includes a curve 502 corresponding to an Early discriminator sequence vector of an Early correlator, a curve 504 corresponding to a Prompt discriminator sequence vector of a Prompt correlator, a curve 506 corresponding to a Late discriminator sequence vector of a Late correlator, and a vertical grid of dashed lines 508 illustrating an example of delta time hypotheses δt′. Each of the curves 502, 504, and 506, represents a weight applied to the corresponding correlator. The vertical grid of dashed lines 508 shows an example of delta time hypotheses δt′. The weight for the Early correlator is 0 in the region 0 to 0.25 chips. As shown in FIG. 5, at times −0.5, 0, and 0.5, respectively, a single curve of the curves 502, 504, and 506 has a value of 1 and the others have a value of 0. By comparison, for all other times, there is a need to combine two or more correlator values in order to locate the maximum of the correlation.

### Example: BPSK Modulation with Infinite Bandwidth

For the case of a GPS L1 C/A, BPSK waveform with infinite bandwidth and three correlators with a spacing of 0.5 chip, i.e., t̅=−0.5, 0, 0.5, and where the impact of H, which models the filtering and resampling operations, and the noise covariance matrix C are neglected, it can be shown that

$${C}_{r} = ( \begin{matrix}1 & 0.5 & 0 \\ 0.5 & 1 & 0.5 \\ 0 & 0.5 & 1\end{matrix} ) , \qquad ( Equation 19 )$$

which is the Toeplitz matrix of the squared autocorrelation in the time domain (triangle waveform), sampled at times −0.5, 0, 0.5 chips. The middle column and middle row can be viewed as corresponding to the Prompt correlator, and its correlation to the Early and Late correlators. The 0 component at the edge is the correlation between the Early and Late correlators.

For an observed vector r_{t̅}, and for a given time hypothesis δt′ (i.e., a vertical dashed line of the vertical grid of dashed lines 508), each of the coordinates of r_{t̅} is multiplied (or weighted) by the corresponding value on each curve, and then summed up. As the time hypothesis is varied, a curve as a function of δt′ is obtained. The maximum of this curve corresponds to the ML estimate of time of arrival.

A further important observation for the case of infinite bandwidth shown in FIG. 5 is that when the time hypothesis is between 0 and 0.5 chips, the formula does not depend on the Early correlator but it depends only on the Prompt and Late correlators. Indeed, the curve 502 for the Early correlator is 0 between 0 and 0.5 chips. This is unlike conventional code phase discriminators that rely especially on the Early and Late correlators, ignoring the Prompt correlator. The observation remains roughly true for bandwidths of 16.368 MHz and 8.184 MHz, and somewhat true for 2.046 MHz.

### Differentiating the Code Phase Discriminator Vectors

Finding the local extremum of |v_{δt′}^{H} r_{t̅}|² can be done per continuous segment, or per short continuous segments, while paying attention to the boundaries between segments. The solution may be determined per segment and checked to determine if the solution falls within the boundaries of the segment. Other potential solutions include the boundaries between segments. Finally, all potential solutions may be compared using Equation 15 in order to select the winning solution.

Differentiating and equating to 0 per continuous segment leads to

$$ℜ e \{ {v}_{δ t ′}^{H} {r}_{\overline{t}} {r}_{\overline{t}}^{H} \frac{{dv}_{δ t ′}}{dt} \} = ℜ e \{ {r}_{\overline{t}}^{H} \frac{{dv}_{δ t ′}}{dt} {v}_{δ t ′}^{H} {r}_{\overline{t}} \} = 0. \qquad ( Equation 20 )$$

An efficient implementation may compute the two projections:

$$r ( δ {t}^{′} ) {=}^{Δ} {v}_{δ t ′}^{H} {r}_{\overline{t}} \qquad ( Equation 21 )$$

$$and$$

$$\mathring{r} ( δ {t}^{′} ) {=}^{Δ} \frac{{dv}_{δ t ′}^{H}}{dt} {r}_{\overline{t}} , \qquad ( Equation 22 )$$

$$and then find δ {t}^{′} such that$$

$$ℜ e \{ r ( δ {t}^{′} ) {\mathring{r}}^{*} ( δ {t}^{′} ) \} = 0 , \qquad ( Equation 23 )$$

$$i . e . ,$$

$$ℜ e \{ r ( δ {t}^{′} ) \} ℜ e \{ \mathring{r} ( δ {t}^{′} ) \} + 𝔗𝔪 \{ r ( δ {t}^{′} ) \} 𝔗𝔪 \{ \mathring{r} ( δ {t}^{′} ) \} = 0. \qquad ( Equation 24 )$$

If r_{t̅} is approximately real-only, then what matters is r̊(δt′)=0 (since r (δt′)=0 is clearly a minimum rather than a maximum). The curves

$$\frac{{dv}_{δ t ′}}{dt}$$

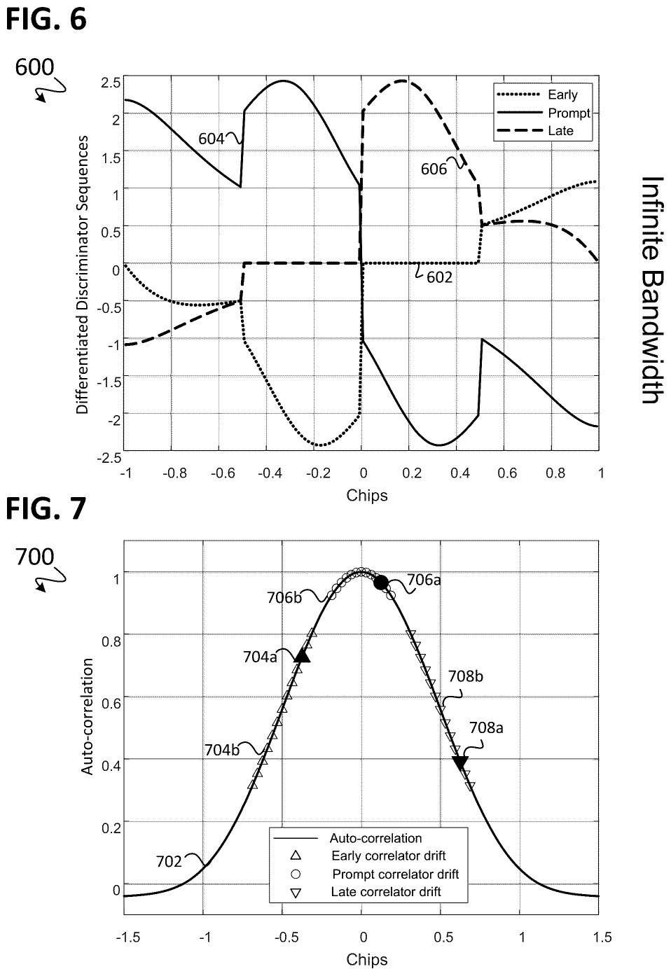

as a function of δt′ are shown in FIG. 6 for BPSK with infinite bandwidth. A simplified graph 600 of FIG. 6 includes a differentiated code phase discriminator curve 602 corresponding to an Early correlator, a differentiated code phase discriminator curve 604 corresponding to a Prompt correlator, and a differentiated code phase discriminator curve 606 corresponding to a Late correlator.

The curves v_{δt′} and/or

$$\frac{{dv}_{δ t ′}}{dt}$$

can be obtained for a grid of points that extend over the range of uncertainty on the time hypothesis. This can be followed by various interpolation techniques (e.g., quadratic) between adjacent grid points to fine-tune δ\hat{t}ᵤ. An alternative is to model every short segment of the curves by a polynomial fit. Precise calculation of

$$\frac{{dv}_{δ t ′}}{dt}$$

could be obtained by differentiating Equation 14b with respect to δt′.

### Timing Drift

As the coherent correlation is prolonged in time, the signals from satellites appear to drift in time due to the Doppler effect, or due to the carrier frequency offset of the received of the mobile device. For example, FIG. 7 includes a graph 700 of correlation functions experiencing timing drift. The graph 700 includes an autocorrelation function 702, an Early correlation 704a, drifting Early correlations 704b, a Prompt correlation 706a, drifting Prompt correlations 706b, a Late correlator 708a, and drifting Late correlations 708b. As the long correlation is broken into the sum of short correlations of about 1 ms, the signal appears to drift across the 1 ms correlation over time.

Although the drift can be ignored with acceptable performance, an improvement is to track the drift and accumulate, per correlator, in short time sections, or short time bins, where the timing drift is negligible. In some embodiments, the timing drift is considered to be negligible within a time bin, i.e., the error can be neglected, if the time bin duration is such that timing drift within the time bin is less than ¼^{th} of the chip rate (which effectively means a drift of +/−⅛^{th} chip on each side of the middle of the bin). The code phase discriminator vector is then slid for each time bin to account for the timing drift. For each time bin of index k, the set t̅(k) denotes the timing of the correlators r_{t̅(k)} for that time bin. The parameter r_{t̅}(k) is only accumulated during the given time bin k. When moving to the next time bin k+1, correlations are accumulated into r_{t̅(k+1)}. The set t̅(k+1) has a small delta time with respect to t̅(k) (e.g., a 20 ms delta time accumulation is performed per bit in GPS L1 C/A).

Then, the code phase discriminator should find the maximum value by accounting for the timing drift. To elaborate, let it be assumed that t̅(k)=t̅(0)+g (k), where g (k) defines the timing delta for each bin relative to the first bin of index 0. It may be assumed that g (0)=0, and often g (k)=αk is proportional to k (it can optionally be a second-order function of k). Then, the code phase discriminator vector is slid as the correlators slide, i.e.,

$$δ {\hat{t}}_{u} = arg {max}_{δ t ′} {\vert {\sum }_{k} {v}_{δ t ′ + g ( k )}^{H} {r}_{\overline{t} ( k )} \vert}^{2} . \qquad ( Equation 25 )$$

In other words, a drifting hypothesis code phase discriminator vector is applied to the drifting correlators. Values are accumulated and the strongest hypothesis is found. This is the ML solution as the main change between bins is the drift, which is accounted for by the phase ramp p_{δt+g (k)} embedded inside v_{δt+g (k)}. The result is δ\hat{t}ᵤ in the above formulation that is referenced to the timing of bin 0.

The advantage of this solution is that there is no need to resample the input signal per satellite. The disadvantage is that it needs the storage of correlators per time bin, as well as a costlier search using the code phase discriminator vectors as the summation is quite long with many more correlators.

However, the number of correlators can be reduced because of periodicity. Indeed, as the timing drifts, at some point, the receiver applies a sample shift. When a sample shift is applied, the timing (within the short correlation of about 1 ms) appears to go back to an older value. The bins realign with older bins similarly to a modulo operation. The function g (k) is in fact in the form of a seesaw, rather than continuously increasing. Therefore, several bins may be accumulated together if they approximately share the same timing drift g (k). This accumulation can be performed before reaching the discriminator stage, and the overall number of r_{t̅(k)} to maintain is reduced. In this version, multiple bins correspond to the same index k, which is the index of the intermediate correlator having a timing drift of g (k).

“Virtual correlators,” may be considered, where each virtual correlator is positioned at a time t̅(k)=t̅(0)+g (k), and receive the accumulation of all bins having this time drift (modulo the input sample realignment). Finally, the summation in the discriminator function is over the virtual correlators rather than the bins as each virtual correlator has already combined the sum of multiple bins that overlap in terms of time drift.

### Non-Coherent Correlation

When the complex amplitude and phase scalar value aᵤ changes between time segments in a manner that cannot be tracked and corrected for coherent correlation, a non-coherent correlation may be used to accumulate multiples of such segments. In this case, an entirely independent aᵤ may be assumed between the segments, so within each segment i, the complex scalar aᵤ is estimated independently of other segments. The ML estimator for the time of arrival is the summation over all segments as follows,

$$δ {\hat{t}}_{u} = arg {max}_{δ t ′} {\sum }_{i} {\vert {v}_{δ t ′}^{H} {r}_{\overline{t}}^{( i )} \vert}^{2} , \qquad ( Equation 26 )$$

i.e., maximize the summation over all time segments of the square of the dot product between the time-segmented correlators vector r_{t̅}⁽ⁱ⁾, per segment i, and the multitude of code phase discriminator vectors v_{δt′} each having hypothesis δt′. The winning hypothesis indicates the time of arrival. A unique v_{δt′} is tested on all segments unless there is timing drift, in which case a drifting v_{δt′+g (k)} is tested per time hypothesis.

In order to perform the above summation, the correlator vectors may need to be stored per time segment until they are all available. However, it is possible to rewrite the formula as follows:

$$\begin{matrix}{\sum }_{i} {\vert {v}_{δ t ′}^{H} {r}_{\overline{t}}^{( i )} \vert}^{2} = {v}_{δ t ′}^{H} ( {\sum }_{i} {r}_{\overline{t}}^{( i )} {r}_{\overline{t}}^{( i ) H} ) {v}_{δ t ′} \\ {=}^{Δ} {v}_{δ t ′}^{H} {\overline{R}}_{\overline{t}} {v}_{δ t ′}\end{matrix} \qquad ( Equation 27 )$$

It is then sufficient to store the accumulated covariance matrix of the correlators R̅_{t̅}≙Σᵢ r_{t̅}⁽ⁱ⁾ r_{t̅}^{(i) H} instead of storing each r_{t̅}⁽ⁱ⁾. Then, the best hypothesis v_{δt′} may be found based on the maximum of v_{δt′}^{H}R̅_{t̅}v_{δt′}.

However, this solution is only optimal according to the ML solution if the assumption that complex scaling aᵤ for a segment is entirely independent of the other segments. This assumption is quite restrictive as typically there is a dependency between aᵤ of adjacent segments, where often the amplitude of aᵤ is roughly unchanged and the phase of aᵤ is not entirely decorrelated between segments. Nevertheless, it typically outperforms the solution where only the diagonal of the covariance matrix of the correlators is considered, ignoring the non-diagonal elements, as is implicitly done in conventional GNSS code phase discriminators (or the square roots of the diagonal elements).

### Impact of PRN Sequences

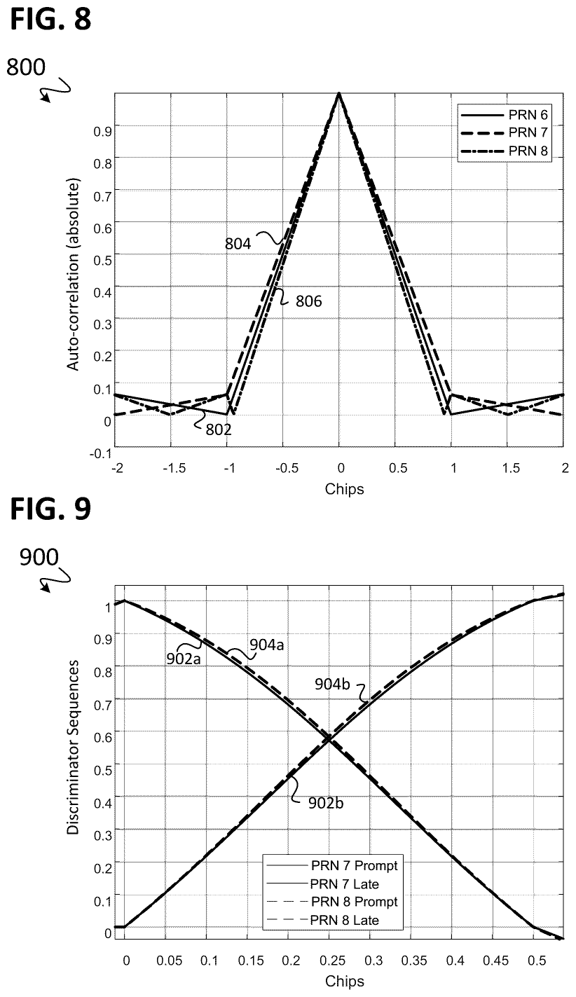

In the description above, a one-chip PRN sequence (i.e., a reference sequence), such as a Dirac impulse times the shaping waveform (BPSK or BOC), has been assumed. However, generally, the PRN sequences have slightly different autocorrelation functions that can impact the code phase discriminator vectors. For instance, in GPS, the autocorrelation function for PRN sequences 6, 7, and 8 are shown in a simplified graph 800 of FIG. 8 as curves 802, 804, and 806 respectively.

Such differences impact the PRN sequences, modeled by vector x, and hence the vectors v_{δt′}. It is an option to ignore this error after the TOA estimate converges near 0 as the difference becomes negligible. Note that this requires precomputing the correlators at least a second time after the near 0 region is determined.

Alternatively, this difference may be taken into account by having a dedicated set of v_{δt′} for each PRN, or for each group of PRN having similar autocorrelation or similar v_{δt′} curves within the time region of interest. In this case, the PRN sequences are constructed with a full PRN (1 ms in the case of GPS PRN L1 C/A) rather than using a unique chip as for a one-chip PRN sequence.

For example, FIG. 9 provides a simplified graph 900 that shows two sets of v_{δt′} curves 902a-b and 904a-b, in accordance with some embodiments. The curves 902a-b correspond to PRN 7 and the curves 904a-b correspond to PRN 8. The curves 902a and 904a correspond to Prompt correlators and the curves 902b and 904b correspond to Late correlators. The small difference between the curves 902a/904a and 902b/904b, if neglected, can lead to a few meter errors for the code phase discriminator of GPS L1 C/A. Accounting for this difference can be done either by having a separate v_{δt′} per PRN, or by grouping multiple PRN per v_{δt′} if the differences are negligible within the group. Through experimentation, it has been observed that seven groups of v_{δt′} can be sufficient for better than 2 m accuracy.

### Simulation Results

Simulations were performed using BPSK modulation, with a square shape in the time domain or a Sinc shape in the frequency domain. The same simulation applies to GPS L1 C/A, GPS L5, and other systems using this waveform. The small impact of the different PRN sequences was ignored. The ranging signal receiver bandwidth was set to 2.346 times the chip rate, i.e., 2.4 MHz for GPS L1 C/A, or 24 MHz for GPS L5. The ranging error is given in chips, where 1 chip is roughly 293 meters for GPS L1 C/A, and 29.3 meters for GPS L5.

The results of two types of simulations are presented: a) a coherent only simulation with 30 dB SNR post coherent accumulation, and b) a non-coherent simulation with 5 dB SNR post coherent accumulation, followed by 50 non-coherent accumulations. The number of correlators was fixed to three with a fixed spacing of 0.5 chips. The uncertainty on the code phase before entering the code phase discriminator is ±0.25, ±0.5, or ±1.0 chip depending on the simulation.

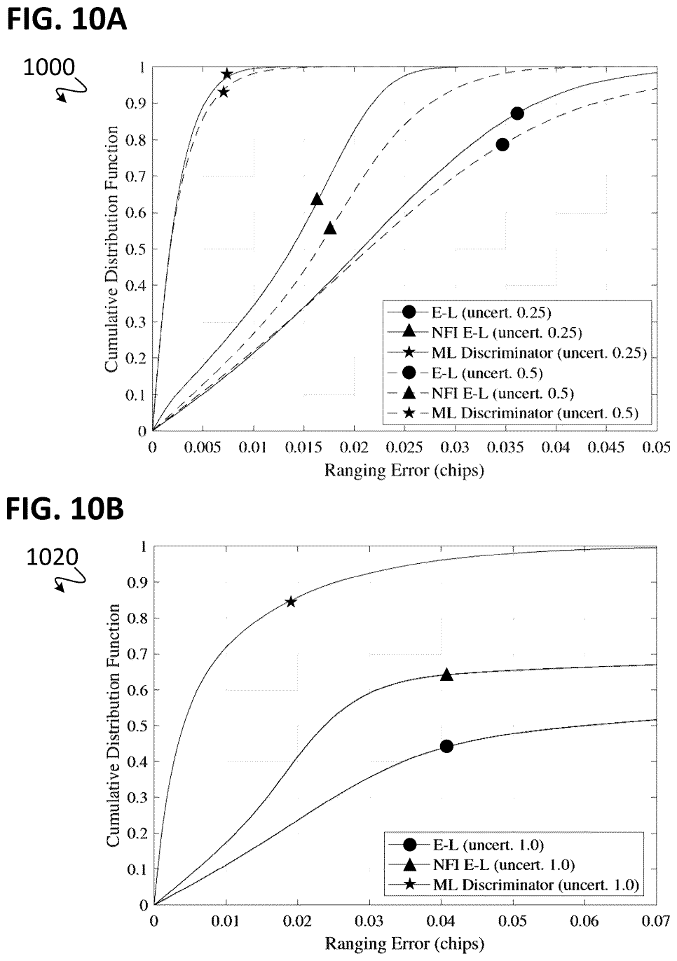

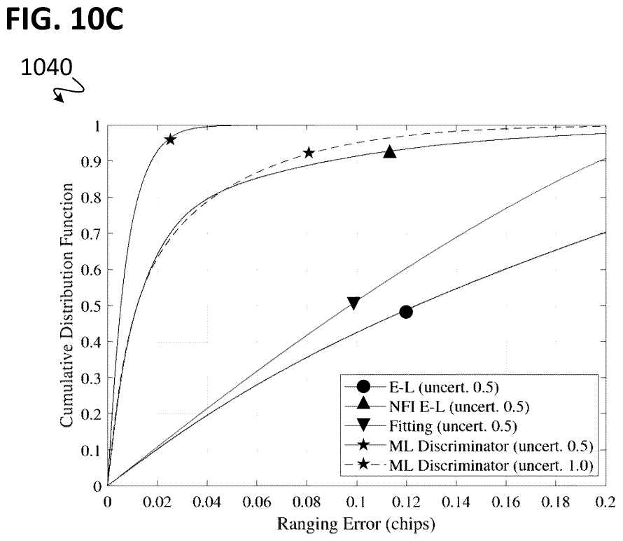

A Cumulative Distribution Function (CDF) of the ranging error in chips is given in the FIGS. 10A-10C. FIG. 10A shows simulation results 1000 having a distribution ranging error for coherent simulation with an SNR of 30 dB post coherent accumulation. The uncertainty before the discriminator is −0.25 to +0.25 chips for solid curves and −0.5 to +0.5 chips for the dashed curves. FIG. 10B provides simulation results 1020 that are similar to those of FIG. 10A but with an uncertainty before the discriminator of −1.0 to +1.0 chips. FIG. 10C provides simulation results 1040 having a distribution of ranging error for a non-coherent example with an SNR of 5 dB post coherent accumulation, followed by 50 non-coherent accumulations.

The ranging error is relative to the time of the correlation peak found using a dense grid of correlators, i.e., the code phase discriminator 402 of FIG. 4. This is what the discriminator should ultimately find for a single path case.

For the ML code phase discriminator in the coherent simulation, the correlators covariance matrix was used as discussed above with reference to non-coherent correlation (there is a small performance hit if only the diagonal matrix is used). In addition to the ML code phase discriminator, results are provided for the well-known non-coherent Early minus Late (E-L) discriminator, for the improved Noise-Floor Independent (NFI) E-L, and for the ‘Fitting’ method without noise whitening of the correlators. Clearly, the ML code phase discriminator substantially outperforms the traditional discriminators, in either the coherent or non-coherent simulations. This is especially true for an initial uncertainty of ±1.0 chip: the traditional code phase discriminators cannot cope with this large uncertainty while the ML code phase discriminators continue to function quite well. The ‘Fitting’ method has a substantially degraded performance at low SNR.

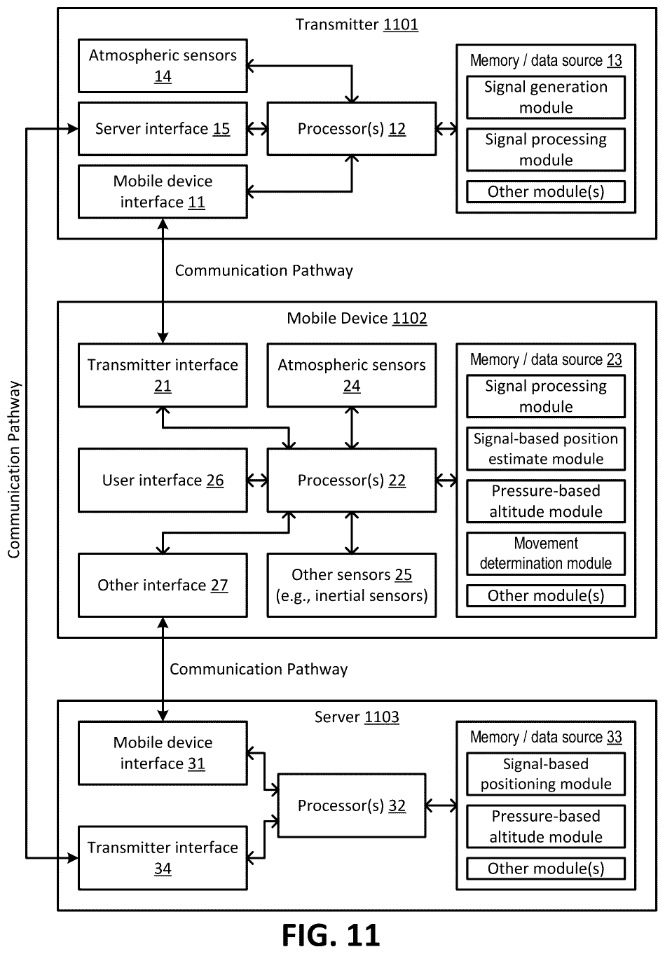

FIG. 11 illustrates components of an example transmitter 1101 (e.g., one of the transmitters 110a-c), an example mobile device 1102 (e.g., one of the mobile devices 120a-b), and an example server 1103 (e.g., any one of the servers 130). Examples of communication pathways are shown by arrows between components. The components shown in FIG. 11 are operable to perform all or a portion of the process 200.

By way of example in FIG. 11, each of the transmitters 1101 may include a mobile device interface 11 for exchanging information with a mobile device (e.g., antenna(s) and RF front-end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the transmitter; a server interface 15 for exchanging information with a server (e.g., an antenna, a network interface, or other); and any other components known to one of ordinary skill in the art. The memory/data source 13 may include a memory storing software modules with executable instructions, and the processor(s) 12 may perform different actions by executing the instructions from the modules, including (i) performance of a part or all of the methods as described herein or otherwise understood by one of skill in the art as being performable at the transmitter; (ii) generation of positioning signals for transmission using a selected time, frequency, code, and/or phase; (iii) processing of signals received from the mobile device or another source; or (iv) other processing as required by operations described in this disclosure. Signals generated and transmitted by a transmitter may carry different information that, once determined by a mobile device or a server, may identify the following: the transmitter; the transmitter's position; environmental conditions at or near the transmitter; and/or other information known in the art. The atmospheric sensor(s) 14 may be integral with the transmitter, or separate from the transmitter and either co-located with the transmitter or located in the vicinity of the transmitter (e.g., within a threshold amount of distance).

By way of example in FIG. 11, the mobile device 1102 may include a transmitter interface 21 for exchanging information with a transmitter (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the mobile device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; another interface 27 for exchanging information with the server or other devices external to the mobile device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the mobile device; (ii) estimation of an altitude of the mobile device based on measurements of pressure from the mobile device and transmitter(s), temperature measurement(s) from the transmitter(s) or another source, and any other information needed for the computation); (iii) processing of received signals to determine position information (e.g., times of arrival or travel time of the signals, pseudoranges between the mobile device and transmitters, transmitter atmospheric conditions, transmitter and/or locations or other transmitter information); (iv) use of position information to compute an estimated position of the mobile device; (v) determination of movement based on measurements from inertial sensors of the mobile device; (vi) GNSS signal processing; or (vii) other processing as required by operations described in this disclosure.

By way of example in FIG. 11, the server 1103 may include a mobile device interface 31 for exchanging information with a mobile device (e.g., an antenna, a network interface, or other); one or more processor(s) 32; memory/data source 33 for providing storage and retrieval of information and/or program instructions; a transmitter interface 34 for exchanging information with a transmitter (e.g., an antenna, a network interface, or other); and any other components known to one of ordinary skill in the art. The memory/data source 33 may include a memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the mobile device; (iii) computation of an estimated position of the mobile device; or (iv) other processing as required by operations described in this disclosure. Steps performed by servers as described herein may also be performed on other machines that are remote from a mobile device, including computers of enterprises or any other suitable machine.

Certain aspects disclosed herein relate to estimating the positions of mobile devices—e.g., where the position is represented in terms of latitude, longitude, and/or altitude coordinates; x, y, and/or z coordinates; angular coordinates; or other representations. Various techniques to estimate the position of a mobile device can be used, including trilateration, which is the process of using geometry to estimate the position of a mobile device using distances traveled by different “positioning” (or “ranging”) signals that are received by the mobile device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the mobile device. Different estimated distances corresponding to different positioning signals from different beacons can be used along with position information like the locations of those beacons to estimate the position of the mobile device. Positioning systems and methods that estimate a position of a mobile device (in terms of latitude, longitude, and/or altitude) based on positioning signals from beacons (e.g., transmitters, and/or satellites) and/or atmospheric measurements are described in co-assigned U.S. Pat. No. 8,130,141, issued Mar. 6, 2012, and U.S. Pat. No. 9,057,606, issued Jun. 16, 2015, incorporated by reference herein in its entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method, comprising:
receiving, at a receiver, a ranging signal from a transmitter, the ranging signal including a reference sequence;
generating, by the receiver, a filtered ranging signal using the received ranging signal;
estimating, by the receiver using the filtered ranging signal, a first estimated time of arrival (TOA) of the received ranging signal;
generating, by the receiver, a filtered local replica of the received ranging signal;
determining, by the receiver, a plurality of first time delay hypotheses of an actual TOA of the received ranging signal;
generating, by the receiver, a correlator vector using the filtered ranging signal, the filtered local replica of the received ranging signal, and the plurality of first time delay hypotheses;
generating, by the receiver, a plurality of code phase discriminator vectors corresponding to a plurality of second time delay hypotheses placed relative to the plurality of first time delay hypotheses, each code phase discriminator vector being based on estimated signal processing, filtering, and noise characteristics of the received ranging signal for a respective second time delay hypothesis; and
determining, by the receiver, a second estimated TOA of the received ranging signal using the correlator vector and the plurality of code phase discriminator vectors, the second estimated TOA being a more accurate estimate of the actual TOA of the received ranging signal as compared to the first estimated TOA.

2. The method of claim 1, wherein the generating a filtered ranging signal comprises:
correcting, by the receiver, Doppler and frequency offsets of the received ranging signal.

3. The method of claim 1, wherein the generating a plurality of code phase discriminator vectors further comprises:
generating, by the receiver, a first set of code phase discriminator vectors for a first reference sequence transmitted by the transmitter; and
generating, by the receiver, a second set of code phase discriminator vectors for a second reference sequence transmitted by the transmitter, the first reference sequence being a different reference sequence than the second reference sequence.

4. The method of claim 1, wherein the determining a plurality of first time delay hypotheses of an actual time of arrival of the received ranging signal comprises:
determining, by the receiver, the plurality of first time delay hypotheses surrounding the first estimated TOA, wherein each time delay hypothesis corresponds to a delta time delay around a time reference that is based on the first estimated TOA.

5. The method of claim 1, wherein:
one or more second time delay hypotheses of the plurality of second time delay hypotheses corresponds to an earlier time than an earliest first time delay hypothesis, or corresponds to a later time than a latest first time delay hypothesis.

6. The method of claim 1, wherein the generating a filtered local replica of the received ranging signal comprises:
creating, by the receiver, a transformation matrix that models signal distortions caused by the filtering and resampling of the received ranging signal; and
generating, by the receiver, a filtered local replica matrix of the received ranging signal by applying the transformation matrix to an unfiltered local replica of the received ranging signal.

7. The method of claim 6, wherein the generating a correlator vector comprises:
generating, by the receiver, for each first time delay hypothesis of the plurality of first time delay hypotheses, a respective phase ramp vector to represent a respective time shift of that first time delay hypothesis in the frequency domain;
generating, by the receiver, a phase ramp matrix by horizontally concatenating the phase ramp vectors;
applying, by the receiver, a noise-whitening filter matrix to the filtered ranging signal; and
generating, by the receiver, the correlator vector by multiplying a Hermitian transpose of the phase ramp matrix with a product of a Hermitian transpose of the filtered local replica matrix of the received ranging signal and the noise-whitened filtered ranging signal.

8. The method of claim 1, wherein the determining a second estimated TOA of the received ranging signal comprises:
projecting, by the receiver, for each second time delay hypothesis, a corresponding code phase discriminator vector onto the correlator vector to generate a corresponding weighted sum;
maximizing a square or a magnitude of the weighted sums; and
generating, by the receiver, the second estimated TOA using a second time delay hypothesis that is associated with a maximum weighted sum.

9. The method of claim 8, wherein:
before projecting, by the receiver, a corresponding code phase discriminator vector onto the correlator vector, differentiating that code phase discriminator vector with respect to time.

10. The method of claim 1, wherein the determining a second estimated TOA of the received ranging signal comprises:
differentiating, by the receiver, each code phase discriminator vector with respect to time to generate a plurality of differentiated code phase discriminator vectors;
generating, by the receiver, for each second time delay hypothesis, a real component projection by determining a real component of a projection of the differentiated code phase discriminator vector and the correlator vector;
generating, by the receiver, for each second time delay hypothesis, an imaginary component projection by determining an imaginary component of a projection of the differentiated code phase discriminator vector and the correlator vector;
identifying, by the receiver, points of extrema where the real component projection and the imaginary component projection sums to zero; and
generating, by the receiver, the second estimated TOA using a second time delay hypothesis associated with the point of extrema.

11. A method, comprising:
receiving, at a receiver, a ranging signal from a transmitter, the ranging signal including a reference sequence;
generating, by the receiver, a filtered ranging signal using the received ranging signal;
estimating, by the receiver using the filtered ranging signal, a first estimated time of arrival (TOA) of the received ranging signal;
generating, by the receiver, a filtered local replica of the received ranging signal;
determining, by the receiver, a plurality of first time delay hypotheses of an actual TOA of the received ranging signal;
segmenting, by the receiver, the filtered ranging signal into a plurality of time bins, each time bin corresponding to a short duration in which a timing drift of the received ranging signal is negligible, and each time bin being associated with a respective amount of timing drift;
generating, by the receiver, a correlator vector using the filtered ranging signal, the filtered local replica of the ranging signal, and the plurality of first time delay hypotheses;
generating, by the receiver, a plurality of code phase discriminator vectors corresponding to a plurality of second time delay hypotheses;
adjusting, by the receiver, the plurality of code phase discriminator vectors for each time bin based on an observed timing drift from previous time bins;
projecting for each time bin, by the receiver, for each second time delay hypothesis, a corresponding adjusted code phase discriminator vector onto the correlator vector to generate a corresponding binned weighted sum;
for each second time delay hypothesis, accumulating, by the receiver, the binned weighted sums over the plurality of time bins;
maximizing a square or a magnitude of the accumulated weighted sums; and
generating, by the receiver, a second estimated TOA using a second time delay hypothesis that is associated with a maximum accumulated weighted sum, the second estimated TOA being a more accurate estimate of the actual TOA of the received ranging signal as compared to the first estimated TOA.

12. The method of claim 11, wherein:
each code phase discriminator vector corresponds to a respective second time delay hypothesis of the plurality of time delay hypotheses and surrounding the first estimated TOA; and
each code phase discriminator vector is based on estimated signal processing, filtering, and noise characteristics of the received ranging signal for that respective second time delay hypothesis.

13. The method of claim 11, wherein the generating a filtered ranging signal comprises:
correcting, by the receiver, Doppler and frequency offsets of the received ranging signal.

14. The method of claim 11, wherein the generating a plurality of code phase discriminator vectors further comprises:
generating, by the receiver, a first set of code phase discriminator vectors for a first reference sequence transmitted by the transmitter; and
generating, by the receiver, a second set of code phase discriminator vectors for a second reference sequence transmitted by the transmitter, the first reference sequence being a different reference sequence than the second reference sequence.

15. A method, comprising:
receiving, at a receiver, a ranging signal from a transmitter, the ranging signal including a reference sequence;
generating, by the receiver, a plurality of time-segmented correlator vectors based on the received ranging signal and a plurality of first time delay hypotheses, each time segment representing a duration over which a complex amplitude and phase of the received ranging signal are independent of one another;
generating, by the receiver, a correlator covariance matrix of the plurality of time-segmented correlator vectors;
generating, by the receiver, a plurality of second time delay hypotheses for the received ranging signal;
generating, by the receiver, a plurality of code phase discriminators corresponding to the plurality of second time delay hypotheses;
projecting, by the receiver, for each second time delay hypothesis, a corresponding code phase discriminator vector onto the correlator covariance matrix;
maximizing a square or a magnitude of the projection onto the correlator covariance matrix; and
generating, by the receiver, an estimated time of arrival (TOA) of the received ranging signal using a second time delay hypothesis that is associated with a maximum of the projection onto the covariance matrix.

16. The method of claim 15, wherein the generating a plurality of code phase discriminator vectors further comprises:
generating, by the receiver, a first set of code phase discriminator vectors for a first reference sequence transmitted by the transmitter; and
generating, by the receiver, a second set of code phase discriminator vectors for a second reference sequence transmitted by the transmitter, the first reference sequence being a different reference sequence than the second reference sequence.

17. A method, comprising:
receiving a ranging signal from a transmitter;
correcting for Doppler and frequency offset of the received ranging signal;
determining a first estimated time of arrival (TOA) which is an approximate TOA estimate of the ranging signal;
computing M correlators around the approximate TOA using the received ranging signal; and
determining a second estimated TOA of the received ranging signal by performing Maximum Likelihood interpolation of the M correlators, the second estimated TOA being a more accurate TOA estimate than the first estimated TOA.

18. The method of claim 17, wherein the determining a second estimated TOA of the received ranging signals comprises:
computing M time projection vectors based on an estimate of a noise component associated with the received ranging signal, a filtering process performed on the received ranging signal, and a correlation process performed on the received ranging signal, each of the M time projection vectors corresponding to a respective one of the M correlators;
selecting a plurality of time hypotheses within the time projection vectors;
for each of the selected time hypotheses, multiplying each correlator value of the M correlators by a value of the respective time projection vector corresponding to that time hypothesis and summing the results to generate a plurality of weighted sums; and
determining the second estimated TOA of the received ranging signal based on the plurality of weighted sums.
